(19) United States
(12) Patent Application Publication
(10) Pub. No.: US 2009/0192921 A1
(43) Pub. Date: Jul. 30, 2009

(54) METHODS AND APPARATUS TO SURVEY A RETAIL ENVIRONMENT

(76) Inventor: Michael Alan Hicks, Clearwater, FL (US)

Correspondence Address: Hanley, Flight & Zimmerman, LLC, 150 S. Wacker Dr. Suite 2100, Chicago, IL, 60606, US

(21) Appl. No.: 12/019,280

(22) Filed: Jan. 24, 2008

(51) Int. Cl. G06Q 10/00; G06Q 30/00; G06K 9/36; G06F 3/048

(52) U.S. Cl. 705/28; 382/284; 715/764

(57) ABSTRACT

Methods and apparatus to survey a retail environment are disclosed herein. A disclosed example method involves moving a cart in a retail establishment having a camera. The method also involves capturing a first image of a first area and a second image of a second area. A stitched image is generated based on the first and second images. The stitched image is associated with product codes based on products appearing in the stitched image.

### FIELD OF THE DISCLOSURE

The present disclosure relates generally to consumer monitoring and, more particularly, to methods and apparatus to survey a retail environment.

### BACKGROUND

Retail establishments and product manufacturers are often interested in the shopping activities, behaviors, and/or habits of people in a retail environment. Consumer activity related to shopping can be used to correlate product sales with particular shopping behavior and/or to improve placements of products, advertisements, and/or other product-related information in a retail environment. Known techniques for monitoring consumer activities in retail establishments include conducting surveys, counting patrons, and/or conducting visual inspections of shoppers or patrons in the retail establishments. Such techniques are often developed by a market research entity based on products and/or services offered in the retail establishment. The names of products and/or services available in a retail establishment can be obtained from store inventory lists developed by retail employees. However, such inventory lists may not include locations of items in the retail establishment to be able to associate a consumer's activity in a particular location with particular products at that location.

### BRIEF DESCRIPTION OF THE DRAWINGS

FIG. 1 illustrates a plan view of an example retail establishment having a plurality of product category zones.

FIG. 2 illustrates an isometric view of an example surveying cart that may be used to implement the example methods and apparatus described herein to survey the retail establishment of FIG. 1.

FIG. 3 depicts a rear view of the example surveying cart of FIG. 2.

FIG. 4 illustrates an example walk-through path in the example retail establishment of FIG. 1 that may be used to perform a survey of the retail establishment.

FIG. 5 depicts products placed on a shelving system of the example retail establishment of FIGS. 1 and 4.

FIGS. 6A and 6B depict example photographic images of the shelving system and products of FIG. 5 captured in succession using the example surveying cart of FIG. 2.

FIGS. 7A and 7B depict the example photographic images of FIGS. 6A and 6B having discard areas indicative of portions of the photographic images to be discarded prior to a stitching process.

FIGS. 8A and 8B depict cropped photographic image portions of the example photographic images of FIGS. 6A, 6B, 7A, and 7B useable for an image stitching process.

FIG. 9 depicts an example stitched photographic image composition formed using the example cropped photographic image portions of FIGS. 8A and 8B.

FIG. 10 is an example navigation assistant graphical user interface (GUI) that may be used to display cart speed status of the example cart of FIG. 2 to assist a person in pushing the cart around the retail environment of FIG. 1.

FIG. 11 is an example graphical user interface that may be used to display photographic images and receive user input associated with categorizing the photographic images.

FIG. 12 is a block diagram of an example apparatus that may be used to implement the example methods described herein to perform product surveys of retail establishments.

FIG. 13 is a flow diagram of an example method that may be used to collect and process photographic images of retail establishment environments.

FIG. 14 is a flow diagram of an example method that may be used to merge images of products displayed in a retail establishment to generate merged, stitched, and/or panoramic images of the displayed products.

FIG. 15 is a flow diagram depicting an example method that may be used to process user input information related to the photographic images collected and processed in connection with the example method of FIGS. 13 and 14.

FIG. 16 is a block diagram of an example processor system that may be used to implement some or all of the example methods and apparatus described herein.

FIG. 17 is a partial view of a cart having a light source and an optical sensor to implement an optical-based dead reckoning system to determine location information indicative of locations traversed by the cart in a retail establishment.

FIG. 18 is an example panoramic image formed using numerous captured images of products displayed in a retail establishment.

### DETAILED DESCRIPTION

Although the following discloses example methods, apparatus, and systems including, among other components, software executed on hardware, it should be noted that such methods, apparatus, and systems are merely illustrative and should not be considered as limiting. For example, it is contemplated that any or all of these hardware and software components could be embodied exclusively in hardware, exclusively in software, or in any combination of hardware and software. Accordingly, while the following describes example methods, apparatus, and systems, the examples provided are not the only way to implement such methods, apparatus, and systems.

The example methods and apparatus described herein may be used to survey products in a retail establishment. For example, the example methods and apparatus may be used to determine the types of products and their locations in a retail establishment to generate a product layout or map of the retail establishment. The product layout can then be used in connection with, for example, consumer behavior monitoring systems and/or consumer surveys to enable product manufacturers to better understand shoppers and how to reach and influence shoppers that buy goods in retail establishments. For example, the in-store product layout can be used to determine when products were on shelves so that shoppers could have been exposed to those products to have the opportunity to purchase those products. The example methods and apparatus described herein can be used to generate product layout maps that can be correlated with purchasing histories to determine how those product layouts affected consumer purchases. In some example implementations, the information about the types of products in retail establishments can be used to confirm that products are temporally and spatially correctly placed in the retail establishments.

The example methods and apparatus described herein can be implemented using a mobile cart having wheels and cameras mounted thereto. A survey person can push the mobile cart through a retail establishment (e.g., through product aisles, through checkout lanes, through storefront areas, etc.) as the cameras capture photographs of products placed in the surrounding areas. To capture the photographs, a retail establishment may be partitioned into multiple areas of interest (e.g., category-based areas, product aisles, etc.). Sequentially captured photographic images for each area of interest are then stitched to form a uniform, continuous panoramic photographic image of those areas of interest. Identifiers for the stitched photographic images can be stored in a database in association with information about products placed in the areas corresponding to those stitched photographic images. To enable users to store information in connection with the photographic images, the cart used to capture the photographic images may be provided with an application having a user interface to display the in-store photographic images and receive user inputs. Alternatively, such an application can be provided at a computer system separate from the cart. The example methods and apparatus described herein may be implemented using any suitable image type including, for example, photographic images captured using a digital still camera, still-picture or freeze-frame video images captured from a video stream, or any other type of suitable image. For purposes of discussion, the example methods and apparatus are described herein as being implemented using photographic images.

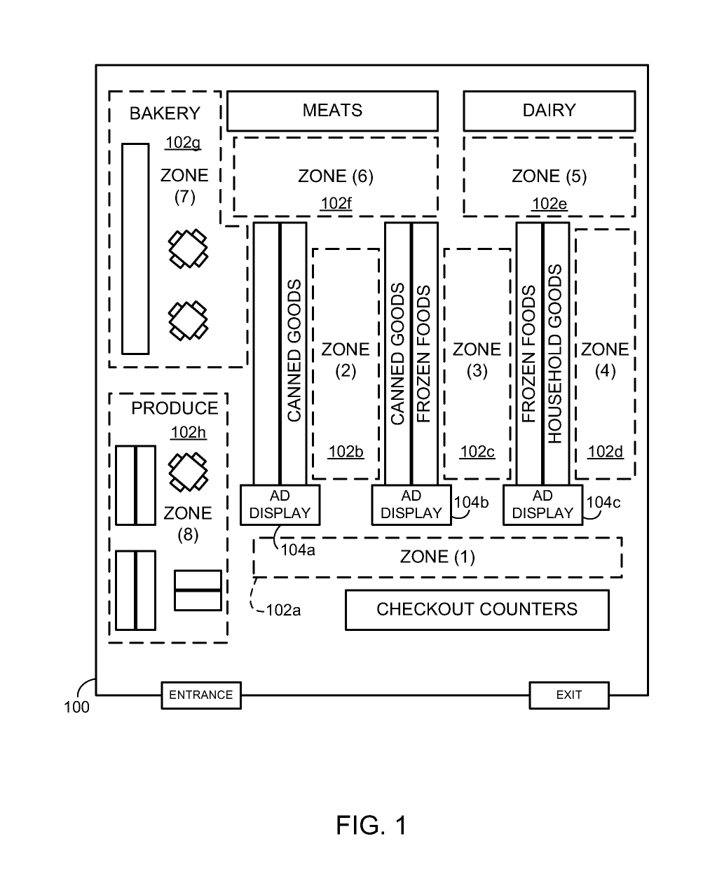

Turning to FIG. 1, an example retail establishment 100 includes a plurality of product category zones 102a-h. In the illustrated example, the retail establishment 100 is a grocery store. However, the example methods and apparatus described herein can be used to survey product layouts in other types of retail establishments (e.g., department stores, clothing stores, specialty stores, hardware stores, etc.). The product category zones 102a-h are assigned sequential numerical values and include a first zone (1) 102a, a second zone (2) 102b, a third zone (3) 102c, a fourth zone (4) 102d, a fifth zone (5) 102e, a sixth zone (6) 102f, a seventh zone (7) 102g, and an eighth zone (8) 102h. A zone is an area of a retail establishment in which a shopper can be expected to have the opportunity to be exposed to products. The boundaries of a zone may relate to product layout throughout the retail establishment and/or natural boundaries that a person could relatively easily perceive. In some example implementations, zones are created based on the types of products that are sold in particular areas of a retail establishment. In the illustrated example, the first zone (1) 102a corresponds to a checkout line category, the second zone (2) 102b corresponds to a canned goods category, the third zone (3) 102c corresponds to a frozen foods category, the fourth zone (4) 102d corresponds to a household goods category, the fifth zone (5) 102e corresponds to a dairy category, the sixth zone (6) 102f corresponds to a meats category, the seventh zone (7) 102g corresponds to a bakery category, and the eighth zone (8) 102h corresponds to a produce category. A department store may have other types of zones in addition to or instead of the category zones 102a-h of FIG. 1 that may include, for example, a women's clothing zone, a men's clothing zone, a children's clothing zone, a household appliance zone, an automotive hardware zone, a seasonal items zone, a pharmacy zone, etc. In some example implementations, surveys of retail establishments may be conducted as described herein without using zones.

In preparation for surveying a particular retail establishment, the retailer may provide a map showing store layout characteristics. The map can be scanned into a database configured to store scanned maps for a plurality of other monitored retail establishments. In addition to providing the map or alternatively, the retailer can also provide a planogram, which is a diagram, a drawing, or other visual description of a retail establishment's layout, including placement of particular products and product categories. If the retailer cannot provide such information, an audit can be performed of the retailer's establishment by performing a walk through and collecting information indicative of products, product categories, and placements of the same throughout the retail establishment. In any case, a category zone map (e.g., the plan view of the retail establishment 100 of FIG. 1) can be created by importing a scanned map and a planogram or other similar information (e.g., audit information) and adding the category zone information (e.g., the category zones 102a-h of FIG. 1) to the map based on the planogram information (or similar information).

In the illustrated examples describe herein, each of the category zones 102a-h is created based on a shopper's point of view (e.g., a shopper's exposure to different areas as the shopper moves throughout the retail establishment). In this manner, the store survey information collected using the example methods and apparatus described herein can be used to make correlations between shoppers' locations in the retail establishment and the opportunity those shoppers had to consume or be exposed to in-store products. For example, a category zone can be created based on a shopper's line of sight when walking down a particular aisle. The category zones can also be created based on natural boundaries throughout a retail establishment such as, for example, changes in floor tile or carpeting, visual obstructions, enclosed areas such as greeting card centers, floral centers, and garden centers.

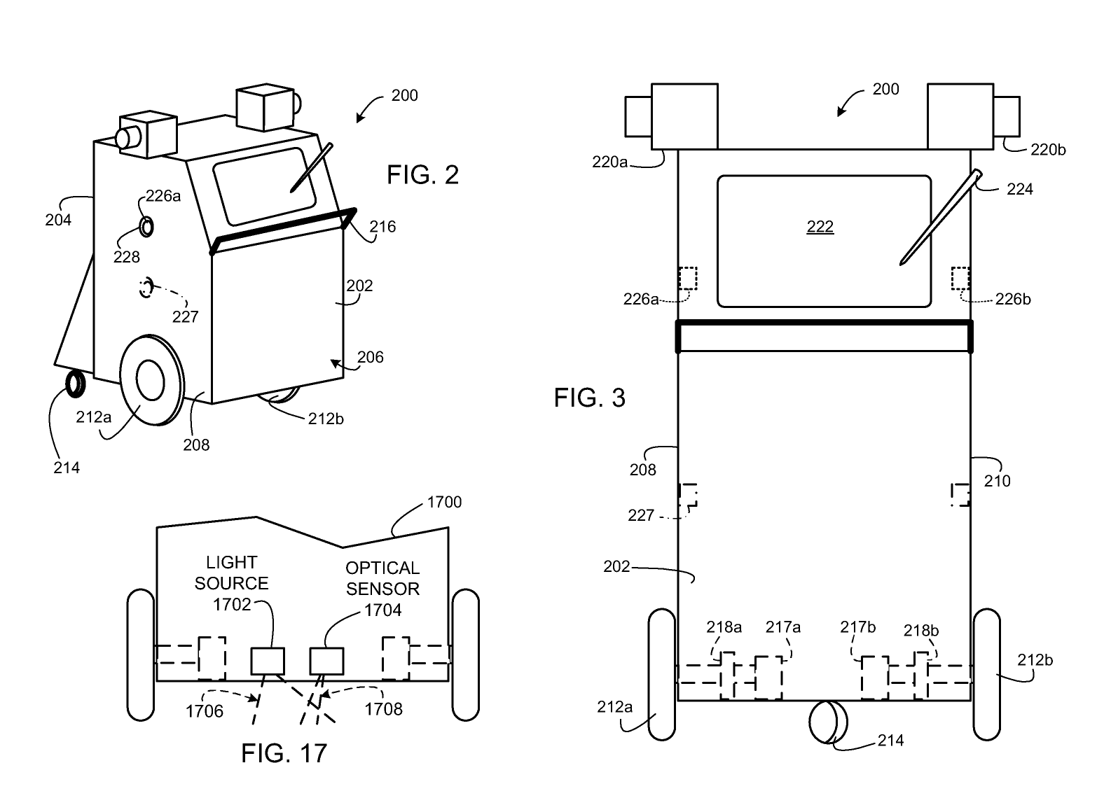

FIG. 2 is an isometric view and FIG. 3 is a rear view of an example surveying cart 200 that may be used to perform surveys of retail establishments (e.g., the example retail establishment 100 of FIG. 1). As shown in FIG. 2, the example surveying cart 200 includes a base 202 having a front side 204, a rear side 206, and two peripheral sides 208 and 210. The surveying cart 200 includes wheels 212a-b rotatably coupled to the base 202 to facilitate moving the cart 200 throughout a retail establishment (e.g., the retail establishment 100 of FIG. 1) during a survey process. To facilitate maneuvering or turning the cart 200, a caster 214 is coupled to the front side 204 (but in other example implementations may be coupled to the rear side 206) of the base 202. The example surveying cart 200 also includes a handle 216 coupled to the rear side 206 to facilitate pushing the cart 200 throughout a retail establishment.

In the illustrated example, each of the wheels 212a-b is independently rotatably coupled to the base 202 via respective arbors 217a-b as shown in FIG. 3 to enable each of the wheels 212a-b to rotate independently of the other when, for example, a user pushes the cart 200 in a turning or swerving fashion (e.g., around a corner, not in a straight line, etc.). In addition, to track the speed and traveling distance of the cart 200, each of the wheels 212a-b is operatively coupled to a respective rotary encoder 218a-b. The rotary encoders 218a-b may alternatively be implemented using any other suitable sensors to detect speed and/or travel distance. To ensure relatively accurate speed and distance detection, the wheels 212a-b can be implemented using a soft rubber material creating sufficient friction with floor surface materials (e.g., tile, ceramic, concrete, sealant coatings, etc.) so that the wheels 212a-b do not slip when the cart 200 is pushed throughout retail establishments.

In the illustrated example, the rotary encoders 218a-b can also be used to implement a wheel-based dead reckoning system to determine the locations traveled by the cart 200 throughout the retail establishment 100. Independently rotatably coupling the wheels 212a-b to the base 202 enables using the differences between the travel distance measured by the rotary encoder 218a and the travel distance measured by the rotary encoder 218b to determine when the cart 200 is turning or is not proceeding in a straight line.

To capture photographic images of products in store aisles, two cameras 220a and 220b are mounted on the surveying cart 200 in an outwardly facing configuration so that the cameras 220a-b have a field of view substantially opposing the peripheral sides 206 and 208 of the surveying cart 200. Each of the cameras 220a-b may be implemented using a digital still camera, a video camera, a web camera, or any other suitable type of camera. In some example implementations, the cameras 220a-b may be implemented using high-quality (e.g., high pixel count) digital still cameras to capture high quality photographic images to facilitate accurate optical character recognition and/or image object recognition processing of the captured photographic images. In the illustrated example, the cameras 220a-b are mounted to the cart 200 so that their fields of view are in substantially perpendicular configurations relative to the direction of travel of the cart 200. To control the image captures of the cameras 220a-b, a shutter trigger signal of each camera may be controlled based on the movement of the wheels 212a-b. For example, the cart 200 may be configured to trigger the cameras 220a-b to capture an image each time the wheels 212a-b rotate a particular number of times based on signals output by one or both of the encoders 218a-b. In this manner, the image capturing operations of the cameras 212a-b can be automated based on the travel distance of the cart 200.

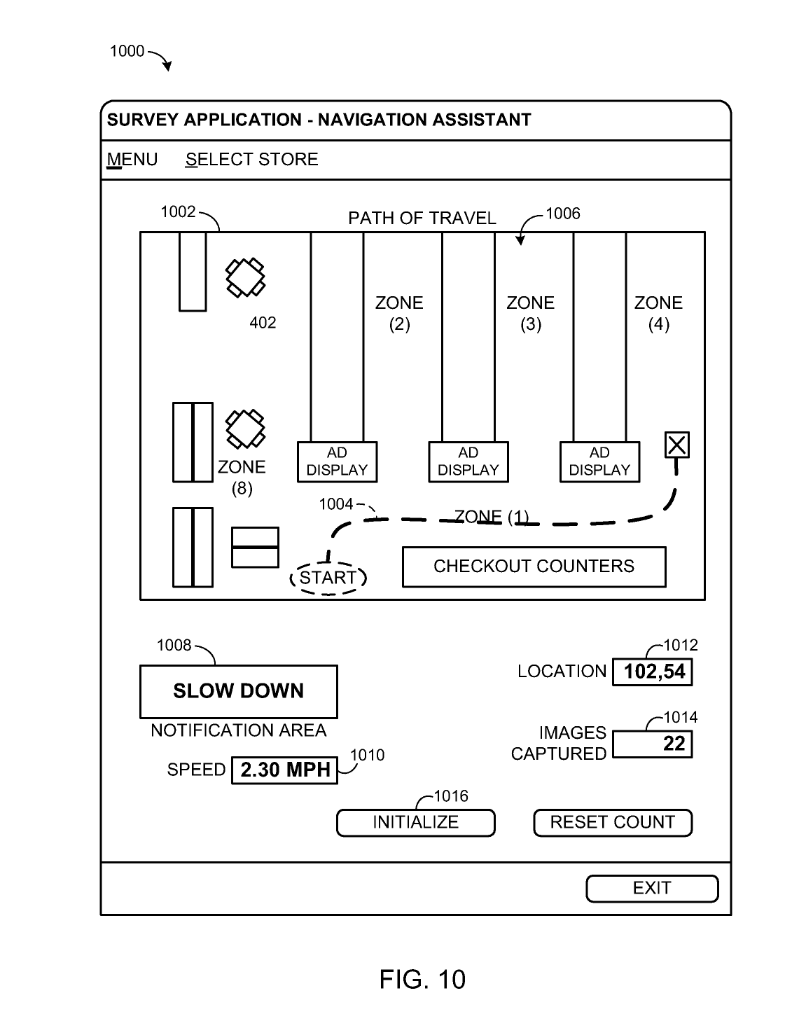

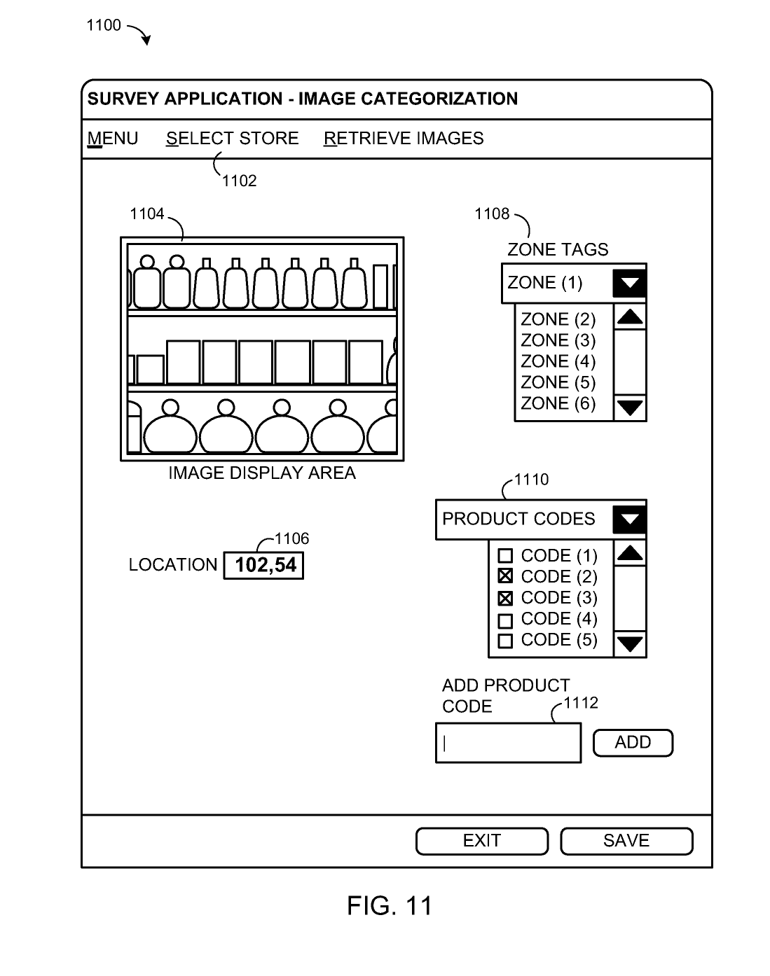

To display captured photographic images, information associated with those photographic images and any other survey related information, the example surveying cart 200 is provided with a display 222. In the illustrated example, the display 222 is equipped with a touchscreen interface to enable users to interact with applications using a stylus 224. Example graphical user interfaces that may be presented on the display 222 in connection with operations of the example surveying cart 200 are described below in connection with FIGS. 10 and 11.

To determine distances between the cart 200 and products (e.g., product shelves, product racks, etc.), the example cart 200 is provided with range sensors 226a and 226b mounted on the peripheral sides 208 and 210. Each of the sensors 226a and 226b is mounted in an outwardly facing configuration and is exposed through a respective aperture (one of which is shown in FIG. 2 and designated by numeral 228) in one of the peripheral sides 208 and 210 to measure distances to objects adjacent to the cart 200. In some example implementations, the cart 200 could be provided with two or more range sensors on each of the peripheral sides 208 and 210 to enable detecting products placed at different heights on product shelves, product racks, or other product furniture. For example, if a product is placed lower than the height of the range sensor 226a, the sensor 226a may measure an invalid or incorrect distance or range, but another range sensor mounted lower on the cart 200 as indicated in FIGS. 2 and 3 by a phantom line and reference numeral 227 can measure the distance or range to the product placed lower than the height of the range sensor 226a. Any number of range sensors substantially similar or identical to the range sensors 226a-b can be provided on each of the peripheral sides 208 and 210 of the cart 200.

FIG. 4 illustrates an example walk-through survey path 400 in the example retail establishment 100 of FIG. 1 that may be used to perform a survey of the retail establishment 100 using the example surveying cart 200 of FIGS. 2 and 3. Specifically, a person can push the surveying cart 200 through the retail establishment 100 in a path generally indicated by the walk-through survey path 400 while the surveying cart 200 captures successive photographic images of products placed on shelves, stands, racks, refrigerators, freezers, etc. As the surveying cart 200 captures photographic images or after the surveying cart 200 has captured all of the photographic images of the retail establishment 100, the surveying cart 200 or another post-processing system (e.g., a post-processing system located at a central facility) can stitch or merge corresponding successive photographic images to create continuous panoramic photographic images of product display units (e.g., shelves, stands, racks, refrigerators, freezers, etc.) arranged in respective aisles or zones. Each stitched, merged, or otherwise compiled photographic image can subsequently be used during an analysis phase to determine placements of products within the retail establishment 100 and within each of the category zones 102a-h (FIG. 1) of the retail establishment 100. In the illustrated example, the survey path 400 proceeds along peripheral areas of the retail establishment 100 and then through aisles. However, other survey paths that proceed along different routes and zone orderings may be used instead.

To determine distances between each of the cameras 220a-b of the cart 200 (FIG. 2) and respective target products that are photographed, the range sensors 226a-b measure distances at range measuring points 402 along the path 400. In some instances in which products are placed on both sides of the cart 200, both of the range sensors 226a-b measure distances on respective sides of the cart 200. For instances in which target products are located only on one side of the cart 200, only a corresponding one of the sensors 226a-b may measure a distance. The distance measurements can be used to measure the widths and overall sizes of shopping areas (e.g., aisle widths, aisle length and/or area size, etc.) and/or category zones.

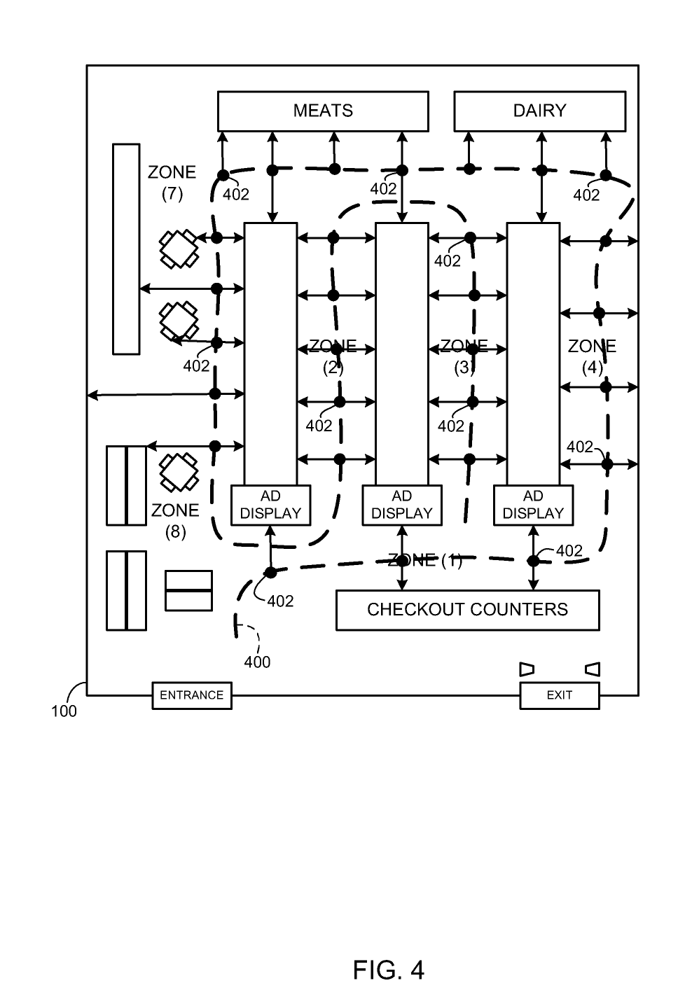

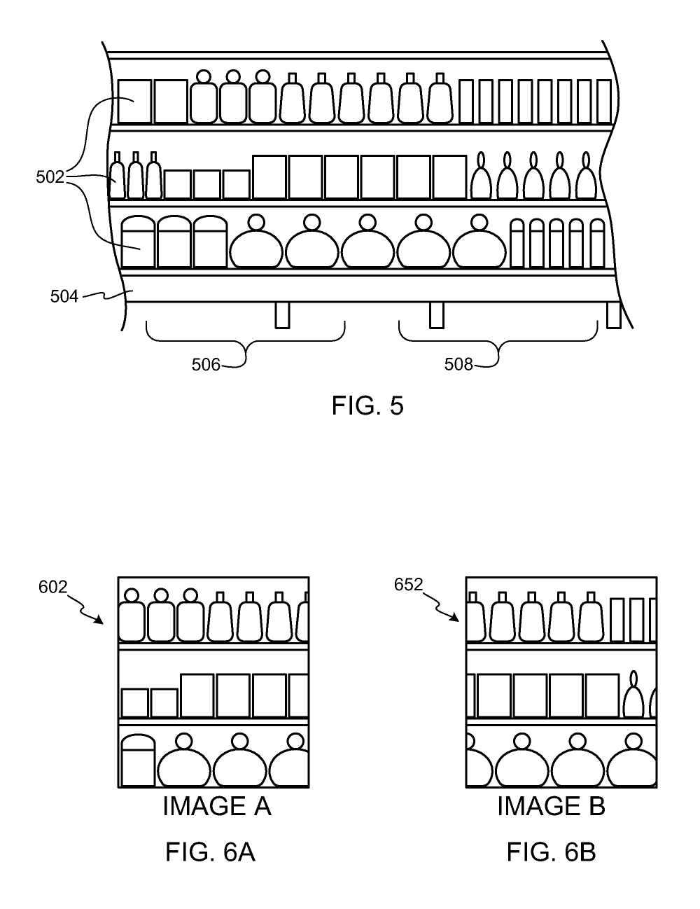

FIG. 5 depicts an arrangement of products 502 placed on a shelving system 504 of the example retail establishment 100 of FIGS. 1 and 4. The arrangement of products 502 is used to illustrate an example technique that may be used to capture successive photographic images of products throughout the retail establishment 100 and stitch or merge the photographic images to form a compilation of successively captured photographic images as a unitary continuous panoramic photographic image depicting products arranged on a product display unit (e.g., shelves, stands, racks, refrigerators, freezers, etc.) of a corresponding aisle or zone.

Turning to FIGS. 6A and 6B, when the cart 200 captures photographic images of the arrangement of products 502, it does so by capturing two successive photographic images, one of which is shown in FIG. 6A and designated as image A 602 and the other of which is shown in FIG. 6B and designated as image B 652. Image A 602 corresponds to a first section 506 (FIG. 5) of the arrangement of products 502, and image B 652 corresponds to a second section 508 (FIG. 5) of the arrangement of products 502. A merging or stitching process is used to join image A 602 and image B 652 along an area that is common to both of the images 602 and 652.

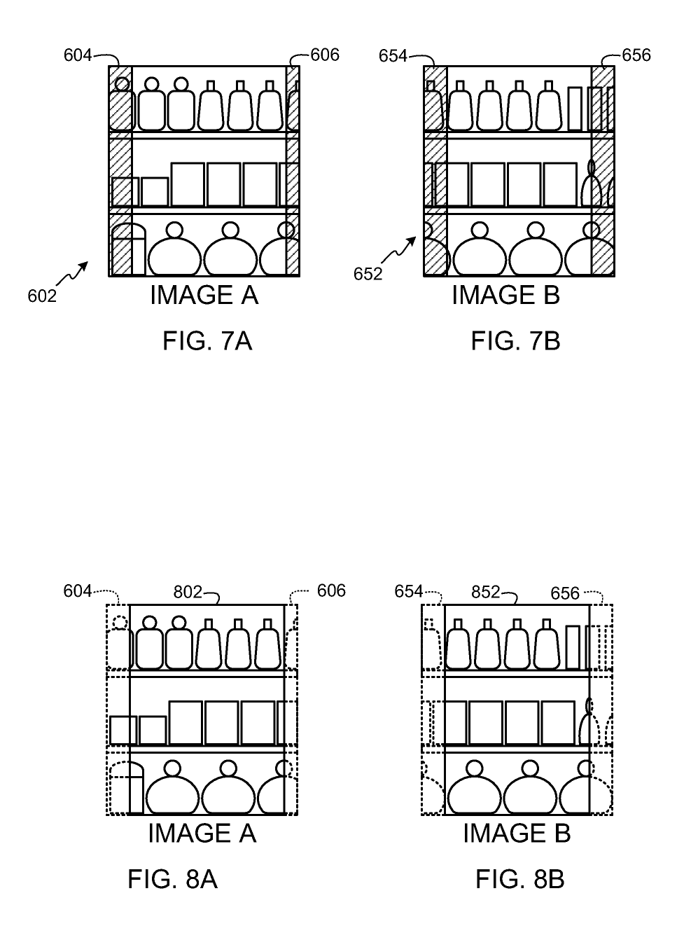

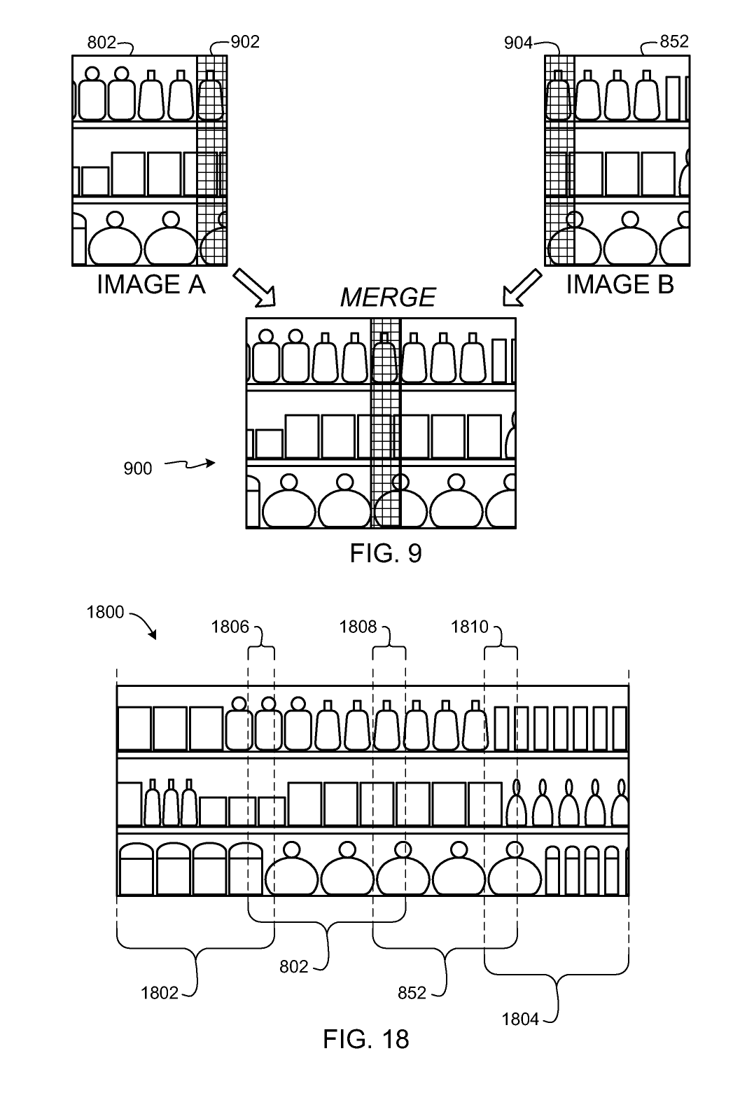

To begin the merging or stitching process, FIG. 7A shows peripheral areas 604 and 606 of image A 602 and FIG. 7B shows peripheral areas 654 and 656 of image B 654 that are identified as areas to be discarded. These areas 604, 606, 654, and 656 are discarded because of a parallax effect in these areas due to lens radial distortion created by the radius of curvature or rounded characteristics of the camera lenses used in connection with the cameras 220a-b of FIGS. 2 and 3. The parallax effect makes objects in the peripheral areas 604, 606, 654, and 656 appear shifted relative to objects at the central or middle portions of the photographic images 602 and 652. This shifting appearance caused by the parallax effect makes it difficult to accurately align a peripheral portion of one photographic image with a corresponding peripheral portion of another photographic image to stitch or merge the photographic images. For example, a parallax effect in the peripheral area 606 of image A 602 corresponds to the peripheral area 654 of image B 652, but the products 502 in respective ones of the peripheral area 606 and 654 will appear shifted in opposite directions due to the parallax effect. Therefore, corresponding edges of the products in the peripheral areas 606 and 654 will not align accurately to generate a merged photographic image having substantially little or no distortion. By discarding the peripheral areas 604, 606, 654, and 656 as shown in FIGS. 8A and 8B to create cropped photographic images 802 and 852, the parallax effect in the remaining peripheral portions (e.g., the peripheral merge areas 902 and 904 of FIG. 9) of the images 602 and 652 used to merge the images 602 and 652 is substantially reduced or eliminated.

FIG. 9 depicts an example stitched or merged photographic image composition 900 formed using the example cropped photographic images 802 and 852 of FIGS. 8A and 8B. In the illustrated example, merge areas 902 and 904 are identified in the cropped photographic images 802 and 852 as having corresponding, overlapping edges and/or image objects based on the ones of the products 502 appearing in those areas 902 and 904. Identifying the merge areas 902 and 904 enables creating the stitched or merged photographic image composition 900 by joining (e.g., overlapping, integrating, etc.) the cropped photographic images 802 and 852 at the merge areas 902 and 904. In the example implementations described herein, numerous photographic images of a product display unit can be merged to form a panoramic image of that product display unit such as, for example, a panoramic image 1800 of FIG. 18. In the illustrated example of FIG. 18, the panoramic image 1800 is formed by merging the photographic images 802, 852, 1802, and 1804 as shown. The photographic images 1802 and 802 are merged at merge area 1806, the photographic images 802 and 852 are merged at merge area 1808, and the photographic images 852 and 1804 are merged at merge area 1810. Although four photographs are shown as being merged to form the panoramic image 1800 in FIG. 18, any number of photographs may be merged to form a panoramic image of products on display in a retail establishment.

FIG. 10 is an example navigation assistant graphical user interface (GUI) 1000 that may be used to display cart speed status of the example cart 200 (FIG. 2) to assist a person in pushing the cart 200 in or around a retail environment (e.g., the retail environment 100 of FIG. 1). In the illustrated example, the navigation assistant GUI 1000 includes a path of travel display area 1002 to display a path of travel plot 1004 indicative of the locations traversed by the cart 200 during a survey. The path of travel plot 1004 is generated based on location information determined using travel distance information generated by the encoders 218a-b. In some example implementations, the path of travel plot 1004 can be generated using filtering algorithms, averaging algorithms or other signal processing algorithms to make the path of travel plot 1004 relatively more accurate, smooth, and/or consistent. In the illustrated example, the path of travel display area 1002 is also used to display a store layout map 1006. In some example implementations, the store layout map 1006 may be indicative of the locations of store furniture (e.g., shelves, counters, stands, etc.) and/or product category zones, and the survey information collected using the example methods and apparatus described herein can be used to determine locations of particular products, advertisements, etc. in the layout map 1006. In other example implementations, the store layout map 1006 may not be displayed. For example, a store layout map of a store being surveyed may not yet exist, but the survey information collected as described herein may subsequently be used to generate a store layout map.

The navigation assistant GUI 1000 is provided with a notification area 1008 to display guidance messages on whether a user should decrease the speed of the cart 200. Also, the navigation assistant GUI 1000 is provided with a speedometer display 1010. As a user pushes the cart 200, the user should attempt to keep the speed of the cart 200 lower than a predetermined maximum speed. An acceptable speed may be predetermined or preselected based on one or more criteria including, a camera shutter speed, an environment lighting speed, the size of the retail environment 100 to be surveyed within a given duration, etc.

To display the location of the cart 200, the navigation assistant GUI 1000 is provided with a location display area 1012. The location information displayed in the location display area 1012 can be generated using location generation devices or location receiving devices of the cart 200. In the illustrated example, the location display area 1012 displays Cartesian coordinates (X, Y), but may alternatively be used to display other types of location information. To display the number of photographic images that have been captured during a survey, the navigation assistant GUI 1000 is provided with an image captured counter 1014.

To initialize the cart 200 before beginning a survey of a retail establishment, the navigation assistant GUI 1000 is provided with an initialize button 10016. In the illustrated example, a user may initialize the cart 200 by positioning the cart 200 to face a direction that is in accordance with the orientation of the store layout map 1006 shown in the path of travel display area 1002 of FIG. 10. Alternatively or additionally, the notification area 1008 can be used to display the direction in which the cart 200 should initially be facing before beginning a survey. The initial direction information displayed in the notification area 1008 can be displayed as store feature information and can include messages such as, for example, face the rear wall of the store, face the front windows of the store, etc. When the cart 200 is positioned in accordance with the store layout map 1006 and/or the direction in the notification area 1008, the user can select the initialize button 1016 to set a current location of the cart 200 to zero (e.g., location coordinates X,Y=0,0). In this manner, subsequent location information can be generated by the cart 200 relative to the zeroed initial location.

FIG. 11 is an example categorization graphical user interface (GUI) 1100 that may be used to display photographic images and receive user input associated with categorizing the photographic images. A person can use the categorization GUI 1100 during or after performing a survey of a retail establishment to retrieve and navigate between the various captured photographic images and tag those images with data pertaining to zones of a store (e.g., the zones 102a-h of FIG. 1). In some example implementations, the example categorization GUI 1100 and its related operations can be implemented using a processor system (e.g., a computer, a terminal, a server, etc.) at a central facility or some other post processing site to which the survey data collected by the cart 200 is communicated. In other example implementations, the cart 200 may be configured to implement the example categorization GUI 1100 and its related operations.

To retrieve photographic images for a particular store, the categorization GUI 1100 is provided with a ‘select store’ menu 1102 via which a person can select the retail establishment for which the person would like to analyze photographic images. To display photographic images, the categorization GUI 1100 is provided with an image display area 1104. In some example implementations, the displayed photographic image is a merged photographic image (e.g., the merged photographic image 900 of FIG. 9) while in other example implementations, the displayed photographic image is not a merged photographic image (e.g., one of the photographic images 602 or 652 of FIGS. 6A and 6B). To display location information indicative of a location within a retail environment (e.g., the retail environment 100 of FIG. 1) corresponding to each photographic image displayed in the image display area 1104, the categorization GUI 1100 is provided with a location display area 1106. In the illustrated example, the location display area 1106 displays Cartesian coordinates (X, Y), but may alternatively be used to display other types of location information. To tag each photographic image with a respective zone identifier, the categorization GUI 1100 also includes a zone tags drop down list 1108 that is populated with a plurality of zones created for the retail establishment associated with the retrieved photographic image. A person can select a zone from the zone tags drop down list 1108 corresponding to the photographic image displayed in the image display area 1104 to associate the selected zone identifier with the displayed photographic image.

To associate product codes indicative of the products (e.g., the products 502 of FIG. 5) shown in the photographic image displayed in the image display area 1104, the categorization GUI 1100 is provided with a product codes selection control 1110. A person may select the product codes associated with the products shown in the displayed photographic image to associate the selected product codes with the displayed photographic image and the zone selected in the zone tags drop down list 1108. In some example implementations, the person may drag and drop zone tags and/or product codes from the zone tags drop down list 1108 and/or the product codes selection control 1110 to the image display area 1104 to associate those selected zone tags and/or product codes with the displayed photographic image.

In some example implementations, product codes in the product code selection control 1110 can be selected automatically using a character recognition and/or an image recognition process used to recognize products (e.g., types of products, product names, product brands, etc.) in images. That is, after the character and/or image recognition process detects particular product(s) in the image display area 1104, one or more corresponding product codes can be populated in the zone tags drop down list 1108 based on the product(s) detected using the recognition process.

To add new product codes, the categorization GUI 1100 is provided with an add product code field 1112. When a person sees a new product for which a product code does not exist in the product codes selection control 1110, the person may add the product code for the new product in the add product code field 1112. The categorization GUI 1100 can be configured to subsequently display the newly added product code in the product codes selection control 1110.

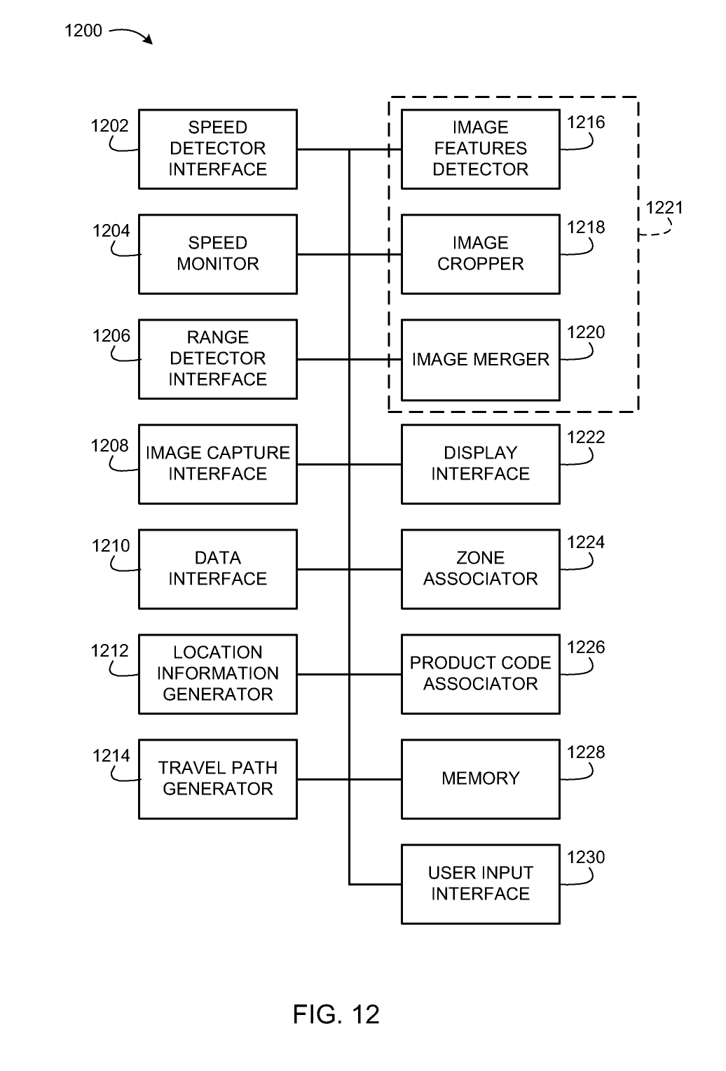

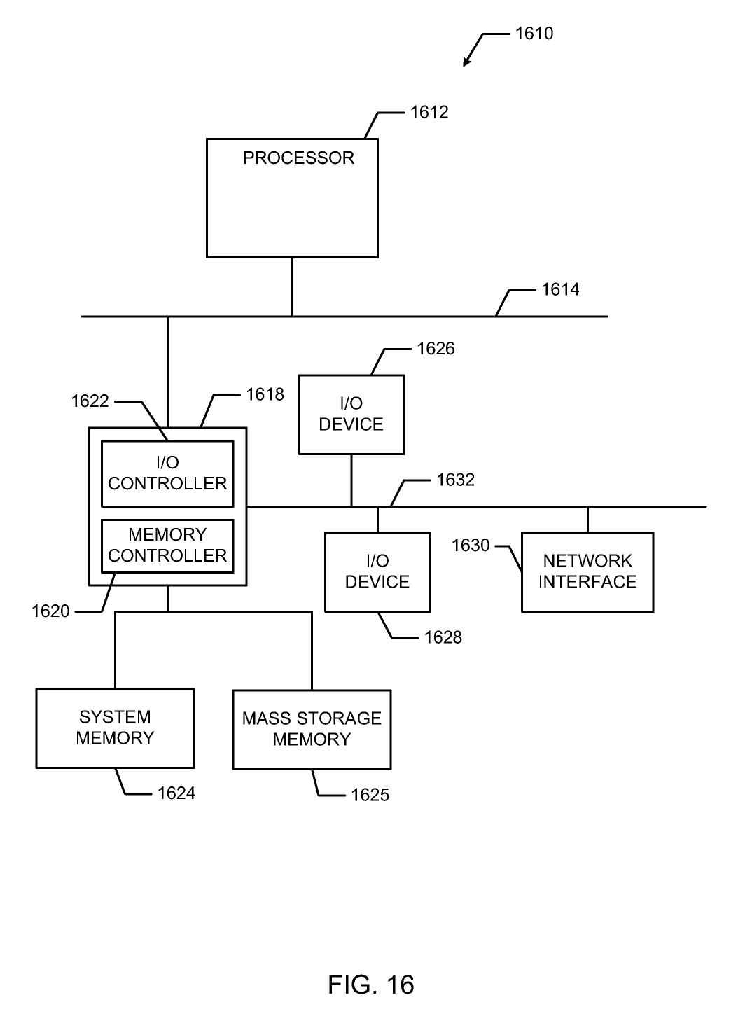

FIG. 12 is a block diagram of an example apparatus 1200 that may be used to implement the example methods described herein to perform product surveys of retail establishments (e.g., the retail establishment 100 of FIG. 1). The example apparatus 1200 may be implemented using any desired combination of hardware, firmware, and/or software. For example, one or more integrated circuits, discrete semiconductor components, and/or passive electronic components may be used. Additionally or alternatively, some or all of the blocks of the example apparatus 1200, or parts thereof, may be implemented using instructions, code, and/or other software and/or firmware, etc. stored on a machine accessible medium that, are executed by, for example, a processor system (e.g., the example processor system 1610 of FIG. 16).

To receive and/or generate speed information based on information from the rotary encoders 218a-b for each of the wheels 212a-b of FIG. 2, the example apparatus 1200 is provided with a speed detector interface 1202. For example, the speed detector interface 1202 may receive rotary encoding information from the rotary encoders 218a-b and generate first speed information indicative of the speed of the first wheel 212a and second speed information indicative of the speed of the second wheel 212b based on that received information. Alternatively, if the rotary encoders 218a-b are configured to generate speed information, the speed detector interface 1202 can receive the speed information from the encoders 218a-b for each of the wheels 212a-b. In some example implementations, the speed detector interface 1202 can use averaging operations to process the speed information for each wheel 212a-b for display to a user via, for example, the navigation assistant GUI 1000 of FIG. 10.

To monitor the speed of the cart 200, the example apparatus 1200 is provided with a speed monitor 1204. In the illustrated example, the speed monitor 1204 is configured to monitor the speed information generated by the speed detector interface 1202 to determine whether the cart 200 is moving too fast during a product survey. A speed indicator value generated by the speed monitor 1204 can be used to present corresponding messages in the notification area 1008 of FIG. 10 to notify a person pushing the cart 200 whether to decrease the speed of the cart 200 or to keep moving at the same pace.

To receive distance information measured by the range sensors 226a-b of FIG. 2, the example apparatus 1200 is provided with a range detector interface 1206. In the illustrated example the range detector interface 1206 is configured to receive distance information from the range sensors 226a-b at, for example, each of the range measuring points 402 depicted in FIG. 4. The distance information may be used to determine the distances between each of the cameras 220a-b and respective target products photographed by the cameras 220a-b.

To receive photographic images from the cameras 220a-b, the example apparatus 1200 is provided with an image capture interface 1208. To store data (e.g., photographic images, zone tags, product codes, location information, speed information, notification messages, etc.) in a memory 1228 and/or retrieve data from the memory 1228, the example apparatus 1200 is provided with a data interface 1210. In the illustrated example, the data interface 1210 is also configured to transfer survey data from the cart 200 to a post-processing system (e.g., the post processing system 1221 described below).

To generate location information, the example apparatus 1200 is provided with a location information generator 1212. The location information generator 1212 can be implemented using, for example, a dead reckoning system implemented using the speed detector interface 1202 and one or more motion detectors (e.g., an accelerometer, a gyroscope, etc.). In the illustrated example, to generate location information using dead reckoning techniques, the location information generator 1212 is configured to receive speed information from the speed detector interface 1202 for each of the wheels 212a-b of the cart 200. In this manner, the location information generator 1212 can monitor when and how far the cart 200 has moved to determine travel distances of the cart 200. In addition, to determine when the cart 200 is turning or swerving, the location information generator 1212 can analyze the respective speed information of each of the wheels 212a and 212b to detect differences between the rotational speeds of the wheels 212a-b to determine when the cart 200 is turning or swerving. For example, if the rotational speed of the left wheel is relatively slower than the rotational speed of the right wheel, the location information generator 1212 can determine that the cart 200 is being turned in a left direction. In some instances, the rotary encoder 218a-b may not be completely accurate (e.g., encoder output data may exhibit some drift) and/or the wheels 212a-b may occasionally lose traction with a floor and slip, thereby, preventing travel information of the cart 200 from being detected by the rotary encoders 218a-b. To compensate for or correct such errors or inaccuracies, the location information generator 1212 can use motion information generated by one or more motion detectors (e.g., an accelerometer, a gyroscope, etc.) as reference information to determine if correction to location information generated based on wheel speeds should be corrected or adjusted. That is, while wheel speed information can be used to generate relatively more accurate travel distance and location information than using motion detectors alone, when wheel slippage or rotational encoder inaccuracies occur, the motion sensor(s) continuously output movement information as long as the cart 200 is moving, and such motion sensor information can be used to make minor adjustments to the travel distance and/or location information derived using the wheel speed information.

In alternative example implementations, the location information generator 1212 can be implemented using an optical-based dead reckoning system that detects travel distances and turning or swerving by the cart 200 using a light source and an optical sensor. For example, referring to FIG. 17 illustrating a partial view of a cart 1700, the location information generator 1212 can be communicatively coupled to a light source 1702 and an optical sensor 1704 (e.g., a black and white complimentary metal-oxide semiconductor (CMOS) image capture sensor) mounted to the bottom of a cart 1700. In the illustrated example, the cart 1700 is substantially similar or identical to the cart 200 except for the addition of the light source 1702 and the optical sensor 1704. In addition, the rotational encoders 218a-b can be omitted from the cart 1700 because the light source 1702 and the optical sensor 1704 would provide travel distance and turning or swerving information. In the illustrated example, the light source 1702 is used to illuminate an area 1706 of floor or surface on which the cart 1700 travels and the optical sensor 1704 captures successive images of an optical capture area 1708 on the surface that are used to determine the speed and directions of travel of the cart 1700. For example, to determine paths of travel (e.g., the paths of travel 400 of FIG. 4 and/or 1004 of FIG. 10) and, thus, location information of the cart 1700, the location information generator 1212 can be configured to perform an optical flow algorithm that compares the images successively captured by the optical sensor 1704 to one another to determine motion, direction, and the speed of travel of the cart 1700. The optical flow algorithm is well known in the art and, thus, is not described in greater detail.

In some example implementations, the location information generator 1212 can also receive camera-to-product distance information from the range detector interface 206 to determine where in a store aisle between two product racks the cart 200 is positioned. This information may be used to display a store layout map in a graphical user interface similar to the store layout of FIG. 4 and display a path of travel on the store layout map to show a user where in the store the user is moving the cart 200. The location information generated by the location information generator 1212 can be associated with respective photographic images captured by the cameras 220a-b. In this manner, the location information for each photographic image can be displayed in, for example, the location information area 1106 of FIG. 11. Although the location information generator 1212 is described as being implemented using a dead reckoning device, any other location information generation or collection technologies can alternatively be used to implement the location information generator 1212.

To generate path of travel information based on, for example, the location information generated by the location information generator 1212, the example apparatus 1200 is provided with a travel path generator 1214. The path of travel information can be used to generate a path of travel through a retail establishment for display to a user while performing a product survey as, for example, described above in connection with FIG. 10.

To perform character recognition and/or image object recognition (e.g., line detection, blob detection, etc.) on photographic images captured by the cameras 220a-b, the example apparatus 1200 is provided with an image features detector 1216. The image features detector 1216 can be used to recognize products (e.g., types of products, product names, product brands, etc.) in images in connection with, for example, the image categorization GUI 1100 for use in associating product codes in the product codes selection control 1110 with photographic images. The image features detector 1216 can also be configured to identify the merge areas 902 and 904 of FIG. 9 to merge the cropped images 802 and 852.

To crop images for a merging process, the example apparatus 1200 is provided with an image cropper 1218. For example, referring to FIGS. 8A and 8B, the image cropper 1218 may crop the peripheral areas 604, 606, 654 and 656 of the photographic images 602 and 652 to produce the cropped photographic images 802 and 852.

To merge or stitch sequentially captured photographic images to form a stitched or merged panoramic photographic image of a product rack, the example apparatus 1200 is provided with an image merger 1220. For example, referring to FIG. 9, the image merger 1220 can be used to merge the cropped images 802 and 852 at the merge areas 902 and 904 to form the merged or stitched image compilation 900.

In some example implementations, the image features detector 1216, the image cropper 1218, and the image merger 1220 can be omitted from the example apparatus 1200 and can instead be implemented as a post processing system 1221 located at a central facility or at some other post processing site (not shown). For example, after the example apparatus 1200 captures and stores images, the apparatus 1200 can upload or communicate the images to the post processing system 1221, and the post processing system 1221 can process the images to form the stitched or merged panoramic photographic images.

To display information via the display 222 of the cart 200 of FIG. 2, the example apparatus 1200 is provided with a display interface 1222. For example, the display interface may be used to generate and display the navigation assistant GUI 1000 of FIG. 10 and the image categorization GUI 1100 of FIG. 11. In addition, the example display interface 1222 may be used to generate and display a layout map of a surveyed retail establishment and a real-time path of travel of the cart 200 as the cart 200 is moved throughout the surveyed retail establishment.

To associate zone information (e.g., the zone tags of the zone tags drop down list 1108 of FIG. 11) with corresponding captured photographic images (e.g., photographic images displayed in the image display area 1104 of FIG. 11), the example apparatus 1200 is provided with a zone associator 1224. In addition, to associate product code information (e.g., the product codes of the product codes selection control 1110 of FIG. 11) with corresponding captured photographic images (e.g., photographic images displayed in the image display area 1104 of FIG. 11), the example apparatus 1200 is provided with a product code associator 1226. To receive user selections of zone tags and product codes, the example apparatus 1200 is provided with a user input interface 1230.

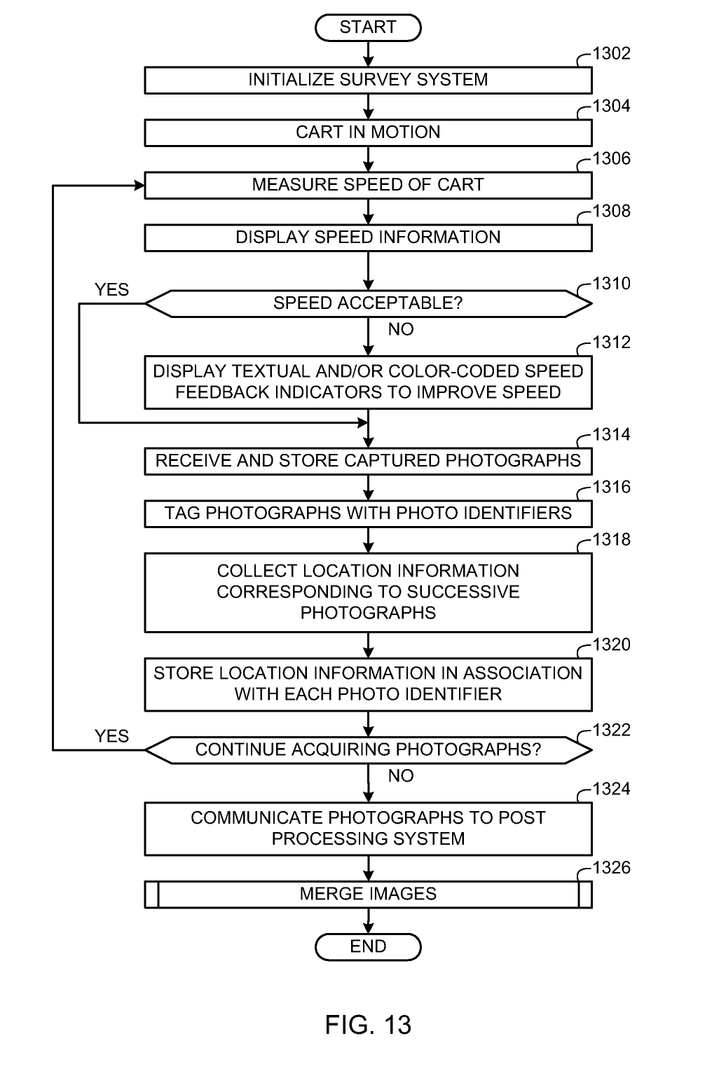

FIGS. 13, 14, and 15 depict flow diagrams of example methods that may be used to collect and process photographic images of retail establishment environments. In the illustrated example, the example methods of FIGS. 13, 14, and 15 are described as being implemented using the example apparatus 1200. In some example implementations, the example methods of FIGS. 13, 14, and 15 may be implemented using machine readable instructions comprising one or more programs for execution by a processor (e.g., the processor 1612 shown in the example processor system 1610 of FIG. 16). The program(s) may be embodied in software stored on one or more tangible media such as CD-ROM's, a floppy disks, hard drives, digital versatile disks (DVD's), or memories associated with a processor system (e.g., the processor system 1610 of FIG. 16) and/or embodied in firmware and/or dedicated hardware in a well-known manner. Further, although the example methods are described with reference to the flow diagrams illustrated in FIGS. 13, 14, and 15, persons of ordinary skill in the art will readily appreciate that many other methods of implementing the example methods may alternatively be used. For example, the order of execution of blocks or operations may be changed, and/or some of the blocks or operations described may be changed, eliminated, or combined.

Turning in detail to FIG. 13, initially the cart 200 (FIGS. 2 and 3) is initialized (block 1302). For example, an initial location of the cart 200 in the retail establishment 100 can be set in the location information generator 1212 to its known location (e.g., an initial reference location) to generate subsequent location information using dead reckoning techniques. As discussed above in connection with FIG. 10, a user may initialize the cart 200 by positioning the cart 200 to face a direction that is in accordance with the orientation of the store layout map 1006 shown in the path of travel display area 1002 of FIG. 10 and/or in accordance with direction information displayed in the notification area 1008 of FIG. 10. When the cart 200 is positioned in accordance with the store layout map 1006 or the direction in the notification area 1008, the user can select the initialize button 1016 to set a current location of the cart 200 to zero, and the cart 200 can subsequently generate location information relative to the zeroed initial location.

After a user places the cart 200 in motion (block 1304), the speed detector interface 1202 (FIG. 12) measures a speed of the cart 200 (block 1306). For example, the speed detector interface 1202 can receive information from the rotary encoders 218a-b and can generate speed information for each of the wheels 212a-b (and/or an average speed of both of the wheels 212a-b) based on the received rotary encoder information. The display interface 1222 then displays the speed information (block 1308) via the display 222 (FIG. 2). For example, the display interface 1222 can display the speed information via the speedometer display 1010 (FIG. 10).

The speed monitor 1204 (FIG. 12) determines whether the speed of the cart 200 is acceptable (block 1310). For example, the speed monitor 1204 may compare the speed generated at block 1306 with a speed threshold or a speed limit (e.g., a predetermined maximum speed threshold) to determine whether the cart 200 is moving at an acceptable speed. An acceptable speed may be predetermined or preselected based on one or more criteria including, a camera shutter speed, an environment lighting speed, the size of the retail environment 100 to be surveyed within a given duration, etc. If the speed is not acceptable (block 1310) (e.g., the speed of the cart 200 is too fast), the speed monitor 1204 causes the display interface 1222 to display textual and/or color-coded speed feedback indicators to inform a user to improve the speed of the cart 200 (block 1312). For example, the speed monitor 1204 may cause the speed interface 1222 to display a notification message in the notification area 1008 (FIG. 10) to decrease the speed of the cart 200.

After displaying the textual and/or color-coded speed feedback indicators (block 1312) or if the speed monitor 1204 determines that the speed of the cart 200 is acceptable (block 1310), the image capture interface 1208 receives and stores successively captured photographic images (e.g., the photographic images 602 and 652 of FIGS. 6A and 6B) from each of the cameras 220a-b (block 1314). For example, the image capture interface 1208 may be configured to trigger the camera 220a-b to capture photographic images at periodic intervals which may be based on a distance traveled by the cart 200. The image capture interface 1208 may obtain the distance traveled by the cart from the speed detector interface 1202 and/or from the location information generator 1212. The distance traveled by the cart 200 may be provided in linear measurement units (e.g., inches, feet, yards, etc.) or may be provided in encoding units generated by the rotary encoders 218a-b. The image capture interface 1208 then tags each of the photographic images with a respective photo identifier (block 1316).

The location information generator 1212 (FIG. 12) collects (or generates) location information corresponding to the location of the cart 200 when each of the photographic images was captured at block 1314 (block 1318). The data interface 1210 then stores the location information generated at block 1318 in association with each respective photo identifier (block 1320) in, for example, the memory 1228. The example apparatus 1200 then determines whether it should continue to acquire photographic images (block 1322). For example, if the product survey is not complete, the example apparatus 1200 may determine that it should continue to acquire photographic images (block 1322), in which case control is returned to block 1306. Otherwise, if the product survey is complete, the example apparatus 1200 may determine that it should no longer continue to acquire photographic images (block 1322).

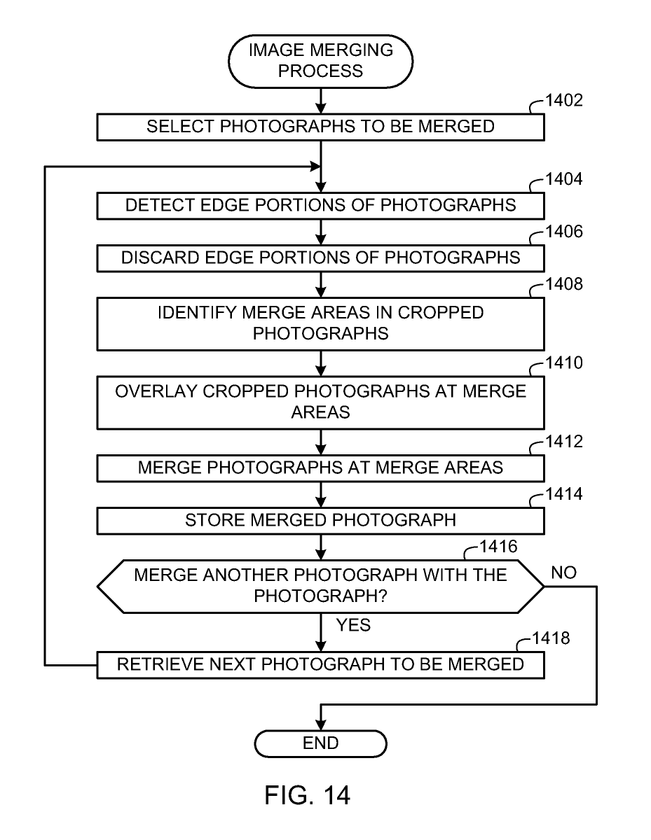

If the example apparatus 1200 determines that it should no longer continue to acquire photographic images (block 1322), the data interface 1210 communicates the stored images, location information, and photo identifiers to the post processing system 1221 (FIG. 12) (block 1324), and the post processing system 1221 merges the images (block 1326) to form panoramic images of product displays. An example process that may be used to implement the example image merging process of block 1326 is described below in connection with FIG. 14. The example process of FIG. 13 is then ended. Although the image merging process of block 1326 is described as being performed by the post processing system 1221 separate from the apparatus 1200 that is implemented on the cart 200, in other example implementations, the image merging process of block 1326 can be performed by the example apparatus 1200 at the cart 200.

Turning to the flow diagram of FIG. 14, to merge the images captured using the cart 200, initially, the post processing system 1221 selects photographs to be merged (block 1402). For example, the post processing system can select the photographic images 602 and 652 of FIGS. 6A and 6B. The image features detector 1216 (FIG. 12) locates the edge portions of the photographic images to be merged (block 1404). For example, the image features detector 1216 can locate the peripheral areas 604, 606, 654, and 656 of the photographic images 602 and 652 based on a predetermined edge portion size to be cropped. The image cropper 1218 (FIG. 12) can then discard the edge portions (block 1406) identified at block 1402. For example, the image cropper 1218 can discard the edge portions 604, 606, 654, and 656 to form the cropped images or photographic images 802 and 852 of FIGS. 8A and 8B.

The image features detector 1216 then identifies merge areas in the cropped photographic images 802 and 852 (block 1408) generated at block 1404. For example, the image features detector 1216 can identify the merge areas 902 and 904 of FIG. 9 based on having corresponding, overlapping edges and/or image objects based on the ones of the products 502 appearing in those areas 902 and 904. The image merger 1220 then overlays the cropped photographic images 802 and 852 at the merge areas 902 and 904 (block 1410) and merges the cropped photographic images 802 and 852 (block 1412) to create the merged or stitched photographic image composition 900 of FIG. 9. The post processing system 1221 then stores the merged photographic image 900 in a memory (e.g., one of the memories 1624 or 1625 of FIG. 16) (block 1410) and determines whether another photograph is to be merged with the merged photographic image 900 generated at block 1412 (block 1416). For example, numerous photographic images of a product display unit can be merged to form a panoramic image of that product display unit such as, for example, the panoramic image 1800 of FIG. 18. If the post processing system 1221 determines that it should merge another photograph with the merged photographic image 900, the post processing system 1221 retrieves the next photograph to be merged (block 1418) and control returns to the operation of block 1404. Otherwise, the example process of FIG. 14 is ended.

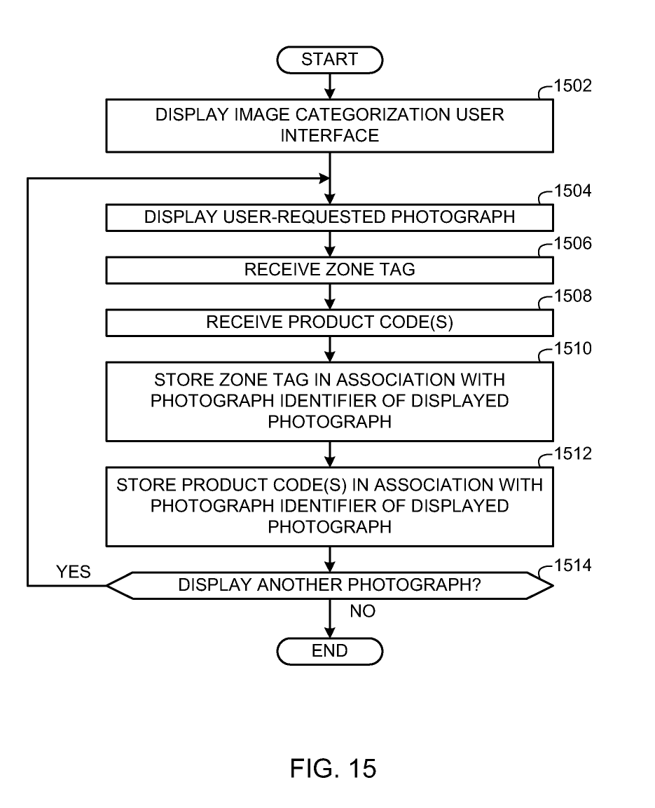

FIG. 15 is a flow diagram depicting an example method that may be used to process user input information (e.g., zone tags, product codes, etc.) related to the photographic images collected and processed in connection with the example methods of FIGS. 13 and 14. In the illustrated example, the example method of FIG. 15 is implemented using the example categorization GUI 1100 of FIG. 11. In some example implementations, the example method of FIG. 15 can be implemented using a processor system (e.g., a computer, a terminal, a server, etc.) at a central facility or some other post processing site to which the survey data collected by the cart 200 is communicated. In other example implementations, the cart 200 may be configured to implement the example method of FIG. 15.

Initially, the display interface 1222 (FIG. 12) displays the image categorization user interface 1100 of FIG. 11 (block 1502) and a user-requested photographic image (block 1504) in the image display area 1104 (FIG. 11). The user input interface 1230 then receives a zone tag (block 1506) selected by a user via the zone tags drop down list 1108 (FIG. 11). In addition, the user input interface 1230 receives one or more product codes (block 1508) selected by the user via the product codes selection control 1110 (FIG. 11). The zone associator 1224 (FIG. 12) stores the zone tag in association with a photographic image identifier of the displayed photographic image (block 1510) in, for example, the memory 1228. The product code associator 1226 (FIG. 12) stores the product code(s) in association with the photographic image identifier (block 1512) in, for example, the memory 1228. The example apparatus 1200 then determines whether it should display another photographic image (block 1514). For example, if the user selects another photographic image for display, control returns to block 1504. Otherwise, if the user closes the image categorization user interface 1100, the example method of FIG. 15 ends.

FIG. 16 is a block diagram of an example processor system that may be used to implement some or all of the example methods and apparatus described herein. As shown in FIG. 16, the processor system 1610 includes a processor 1612 that is coupled to an interconnection bus 1614. The processor 1612 may be any suitable processor, processing unit or microprocessor. Although not shown in FIG. 16, the system 1610 may be a multi-processor system and, thus, may include one or more additional processors that are identical or similar to the processor 1612 and that are communicatively coupled to the interconnection bus 1614.

The processor 1612 of FIG. 16 is coupled to a chipset 1618, which includes a memory controller 1620 and an input/output (I/O) controller 1622. As is well known, a chipset typically provides I/O and memory management functions as well as a plurality of general purpose and/or special purpose registers, timers, etc. that are accessible or used by one or more processors coupled to the chipset 1618. The memory controller 1620 performs functions that enable the processor 1612 (or processors if there are multiple processors) to access a system memory 1624 and a mass storage memory 1625.

The system memory 1624 may include any desired type of volatile and/or non-volatile memory such as, for example, static random access memory (SRAM), dynamic random access memory (DRAM), flash memory, read-only memory (ROM), etc. The mass storage memory 1625 may include any desired type of mass storage device including hard disk drives, optical drives, tape storage devices, etc.

The I/O controller 1622 performs functions that enable the processor 1612 to communicate with peripheral input/output (I/O) devices 1626 and 1628 and a network interface 1630 via an I/O bus 1632. The I/O devices 1626 and 1628 may be any desired type of I/O device such as, for example, a keyboard, a video display or monitor, a mouse, etc. The network interface 1630 may be, for example, an Ethernet device, an asynchronous transfer mode (ATM) device, an 802.11 device, a DSL modem, a cable modem, a cellular modem, etc. that enables the processor system 1610 to communicate with another processor system.

While the memory controller 1620 and the I/O controller 1622 are depicted in FIG. 16 as separate functional blocks within the chipset 1618, the functions performed by these blocks may be integrated within a single semiconductor circuit or may be implemented using two or more separate integrated circuits.

Although the above description refers to the flowcharts as being representative of methods, those methods may be implemented entirely or in part by executing machine readable instructions. Therefore, the flowcharts are representative of methods and machine readable instructions.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A method, comprising:
moving a cart in a retail establishment, wherein the cart includes at least one camera mounted on the cart;
capturing a first image of a first area and a second image of a second area;
generating a stitched image based on the first and second images; and
associating the stitched image with product codes based on products appearing in the stitched image.

2. A method as defined in claim 1, wherein generating the stitched image based on the first and second images comprises:
identifying a first region of the first image that is substantially similar to a second region of the second image;
overlaying the first region onto the second region; and
merging the first and second images via the overlaid first and second regions.

3. A method as defined in claim 1, further comprising measuring a distance from the example cart to a target area in a field of view of the camera.

4. A method as defined in claim 1, further comprising generating location information indicative of a location at which the first image was captured and storing the location information in association with the first image.

5. A method as defined in claim 4, wherein generating the location information comprises collecting rotary encoder measurement information indicative of a travel of a wheel of the cart and generating the location information based on the rotary encoder measurement information.

6. A method as defined in claim 1, wherein the stitched image is representative of a shelving unit in the retail establishment.

7. A method as defined in claim 1, further comprising tagging each of the images of the stitched image with location information indicative of the locations at which the images were captured in the retail establishment.

8. A method as defined in claim 1, further comprising storing categorical zone information in association with at least one of the first image or the second image, wherein the categorical zone information is indicative of products or services corresponding to the contents of the at least one of the first image or the second image.

9. A method as defined in claim 1, further comprising displaying at least one of the first image or the second image via a user interface, receiving user input via the user interface, and storing information in association with at least one of the first image or the second image based on the user input.

10. A method as defined in claim 9, wherein receiving the user input involves receiving the user input via a drag and drop event.

11. A method as defined in claim 1, further comprising displaying a speed indicator indicative of the speed of the cart.

12. A method as defined in claim 1, further comprising displaying a path of travel of the cart indicative of locations traveled by the cart in the retail establishment.

13. A method as defined in claim 12, further comprising displaying a layout map of the retail establishment and displaying the path of travel in association with the layout map.

14. A method as defined in claim 1, further comprising discarding first and second portions of the first image and third and fourth portions of the second image prior to generating the stitched image.

15. (canceled)

16. (canceled)

17. An apparatus, comprising:
a camera interface to receive a first image of a first area and a second image of a second area from at least one camera, wherein the at least one camera is mounted on a cart;
an image merger to generate a stitched image based on the first and second images; and
a product code associator to associate the stitched image with product codes based on products appearing in the stitched image.

18. An apparatus as defined in claim 17, further comprising an image features detector to identify a first region of the first image that is substantially similar to a second region of the second image, wherein the image merger is to overlay the first region onto the second region and merge the first and second images via the overlaid first and second regions.

19. An apparatus as defined in claim 17, further comprising measuring a distance from the example cart to a target area in a field of view of the camera.

20. An apparatus as defined in claim 17, further comprising:
a location information generator to generate location information indicative of a location at which the first image was captured; and
a data interface to store the location information in association with the first image.

21. (canceled)

22. (canceled)

23. An apparatus as defined in claim 17, further comprising a data interface to store location information in association with each of the images of the stitched image indicative of the locations at which the images were captured in the retail establishment.

24. An apparatus as defined in claim 17, further comprising a zone associator to associate categorical zone information in association with at least one of the first image or the second image, wherein the categorical zone information is indicative of products or services corresponding to the contents of the at least one of the first image or the second image.

25. An apparatus as defined in claim 17, further comprising:
a display interface to display at least one of the first image or the second image via a user interface;
a user input interface to receive user input via the user interface; and
a data interface to store information in association with at least one of the first image or the second image based on the user input.

26. (canceled)

27. (canceled)

28. An apparatus as defined in claim 17, wherein the display interface is further to display a path of travel of the cart indicative of locations traveled by the cart in the retail establishment.

29. An apparatus as defined in claim 28, wherein the display interface is further to display a layout map of the retail establishment and display the path of travel in association with the layout map.

30. (canceled)

31. (canceled)

32. An apparatus as defined in claim 17, wherein the at least one camera is mounted on the cart in an outwardly facing configuration toward a field of view substantially perpendicular to the direction of travel of the cart.

33. A machine accessible medium having instructions stored thereon that, when executed, cause a machine to:
detect movement of a cart in a retail establishment, wherein the cart includes at least one camera mounted on the cart;
capture a first image of a first area and a second image of a second area;
generate a stitched image based on the first and second images; and
associate the stitched image with product codes based on products appearing in the stitched image.

34-47. (canceled)
